(19) United States
(12) Patent Application Publication
(10) Pub. No.: US 2015/0178863 A1
(43) Pub. Date: Jun. 25, 2015

(54) INTEGRATED SERVICE FOR FOOD SERVICE

(71) Applicant: CERTEFI, INC., Palo Alto, CA (US)

(72) Inventor: Peter John Bostwick, Menlo Park, CA (US)

(21) Appl. No.: 14/582,014

(22) Filed: Dec. 23, 2014

Related U.S. Application Data
(60) Provisional application No. 61/920,042, filed on Dec. 23, 2013.

(51) Int. Cl. G06Q 50/12; G06Q 30/06

(52) U.S. Cl. CPC G06Q 50/12; G06Q 30/0633

(57) ABSTRACT

A method for integrated food service includes: generating food service data from one or more on-site components; storing the food service data in a data repository; accessing the food service data over the internet through an administrative portal, wherein the administrative portal is configured to provide communication between the data repository and the one or more on-site components.

### CROSS-REFERENCE TO RELATED APPLICATION(S)

This application claims the benefit of U.S. Provisional Application No. 61/920,042, filed Dec. 23, 2013 (Atty. Docket No.: 120110-004PRV), the disclosure of which is incorporated herein in its entirety by reference.

### BACKGROUND

1. Technical Field

Systems and methods consistent with the present inventive concept relate to end-to-end food services, and more particularly to systems and methods for providing integrated food service systems.

2. Related Art

Food service customers are increasingly expecting to be able to choose and purchase items using a variety of methods and technologies. These include self-service ordering, self-service payments, and custom ordering, as well as full service and table side ordering.

In addition, food service providers need to reduce the costs of providing these services. Labor costs are the highest expense for food service companies, even higher than food costs. Thus, reducing the number and time that workers need to be onsite is a direct benefit.

Food service companies spend a great deal of time integrating disparate systems to provide the desired services. There is, however, little technical integration. Integration is left up to individual operation units, resulting in duplicate entry and wasted effort.

### SUMMARY

Systems and methods for providing integrated food service systems are provided.

According to various embodiments there is provided a method. In some embodiments, the method may include: generating food service data from one or more on-site components; storing the food service data in a data repository; and accessing the food service data via the internet through an administrative portal, wherein the administrative portal may be configured to provide communication between the data repository and the one or more on-site components.

According to various embodiments there is provided a system. In some embodiments, the system may include: one or more on-site components configured to generate food service data; a data repository configured to store the generated food service data; and an administrative portal. The administrative portal may be configured to provide communication between the data repository and the one or more on-site components.

Other features and advantages of the present inventive concept should be apparent from the following description which illustrates by way of example aspects of the present inventive concept.

### BRIEF DESCRIPTION OF THE DRAWINGS

Aspects and features of the present inventive concept will be more apparent by describing example embodiments with reference to the accompanying drawings, in which:

FIG. 1 is a diagram illustrating conceptual restaurant layouts for an integrated food service system according to various embodiments;

FIG. 2 is a diagram illustrating a conceptual kitchen layout for an integrated food service system according to various embodiments;

FIG. 3 is a flowchart illustrating a method according to various embodiments;

and

FIG. 4 is a flowchart illustrating a method according to various embodiments.

### DETAILED DESCRIPTION

While certain embodiments are described, these embodiments are presented by way of example only, and are not intended to limit the scope of protection. The methods and systems described herein may be embodied in a variety of other forms. Furthermore, various omissions, substitutions, and changes in the form of the example methods and systems described herein may be made without departing from the scope of protection.

An integrated food service system may include a data repository and administrative portal. The administrative portal may be accessed over the internet. On-site at a service location, individual components that are designed to meet specific user needs may be provided. The administrative portal may provide communication between the data repository and on-site components. Users of the system may benefit from the increased flexibility with which they can interact to choose and pay for their purchases. Food service providers may benefit from improved efficiencies of operation by reduced number and hours that staff is required; end-to-end tracking of inventory; and end-to-end order management.

The present inventive concept may provide management functions for managing an individual location or a chain of locations, including managing products and pricing, inventory, and generating reports.

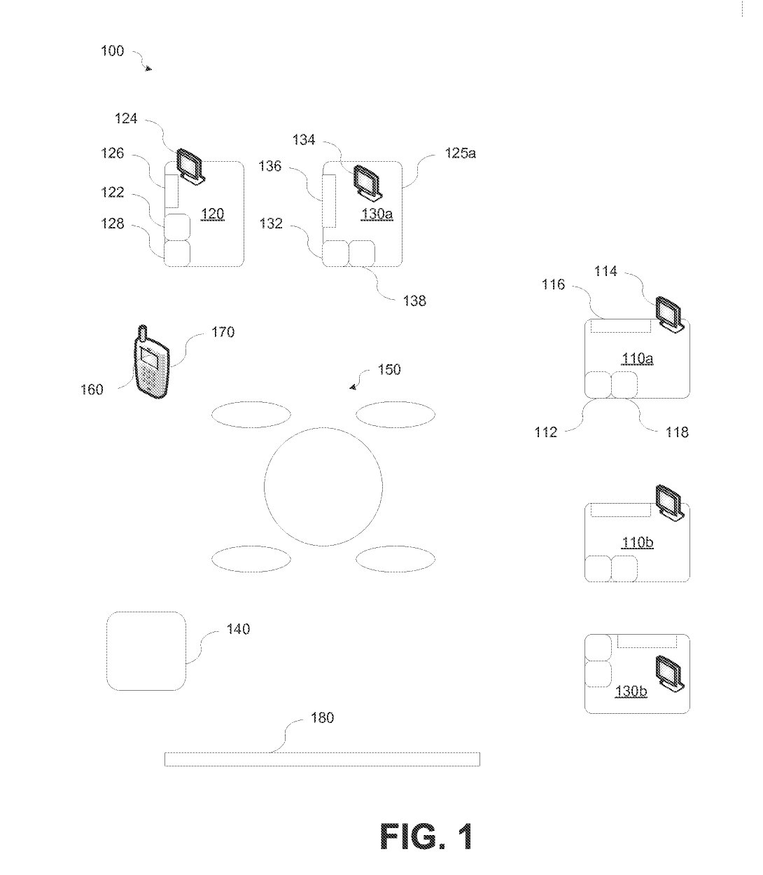

FIG. 1 is a diagram illustrating conceptual restaurant layouts 100 for an integrated food service system according to various embodiments.

Referring to FIG. 1, an integrated food service system 100 may provide on-site components including, but not limited to, one or more full service checkout stations 110a, 110b, one or more self-service checkout stations 120, one or more hybrid (e.g., full service/self-service) checkout stations 130a. 130b, one or more recharge stations 140, one or more ordering stations 150, or any combination of the above. The full service checkout stations 110a. 110b, self-service checkout stations 120, and hybrid checkout stations 130a, 130b are collectively referred to herein as checkout stations.

A mobile browser/ordering site/app and/or web browser/ordering site 160 may be provided for remote interaction with the integrated food service system 100 by a mobile communication device 170. Table service and/or digital signage may also be provided.

A full service checkout station 110a, 110b may be implemented with cashiers to assist customers with purchasing items. The full service checkout station 110a, 110b may allow a cashier to scan items via a scanner 112, for example, but not limited to an infrared (IR) scanner, a bar code scanner, etc. Alternatively or additionally, the full service checkout station 110a, 110b may allow a cashier to choose items from a display on a touch screen terminal 114, accept cash, credit, debit, and other forms of payment via a payment receiving unit 116, and print receipts from a receipt printer 118, as well as provide full administration capabilities.

The payment receiving unit 116 may include, for example, but not limited to, a cash drawer, magnetic strip reader, radio frequency identification (RFID) reader, etc. Alternatively, the full service checkout station 110a, 110b may generate a receipt for rendering payment at another on-site component, for example, but not limited to, the recharge station 140.

A self-service checkout station 120 may include a scanner 122, for example, but not limited to a bar code scanner, a touch screen terminal 124, a payment receiving unit 126. The payment receiving unit 126 may include, for example, but not limited to, a cash receiving/dispensing device (e.g., a bill acceptor/recycler and/or coin mechanism), magnetic strip reader, radio frequency identification (RFID) reader, etc., and a receipt printer 126.

The self-service checkout station 120 may permit customers to scan items via the scanner 122 or choose their items from a display on the touch screen terminal 124 and pay with credit/debit or other form of payment via the payment receiving unit 126. Receipts may be printed with the receipt printer 126 or e-mailed. Alternatively, the self-service checkout station 120 may generate a receipt for rendering payment at another on-site component, for example, but not limited to, the recharge station 140.

A hybrid (full service/self-service) checkout station 130a, 130b may include a scanner 132, for example, but not limited to a bar code scanner, a touch screen terminal 134, and a receipt printer 136. The touch screen terminal 134 may be switched from full service mode to a self-checkout mode by the cashier. Video instructions or images from the video instructions may be displayed on the touch screen terminal 134 to guide customers through the checkout process.

The payment receiving unit 136 may include, for example, but not limited to, a cash drawer, a cash receiving/dispensing device (e.g., a bill acceptor/recycler and/or coin mechanism), magnetic strip reader, radio frequency identification (RFID) reader, etc., In full service mode, the payment receiving unit 136 may accept cash, credit, debit, and other forms of payment. In self-service mode, the cash drawer may be manually and/or automatically locked and cash payment accepted only by the bill acceptor/recycler and coin mechanism. Alternatively, the hybrid checkout station 130a, 130b may generate a receipt for rendering payment at another on-site component, for example, but not limited to, the recharge station 140.

Purchase transactions may be completed at any full service checkout station 110a, 110b, self-service checkout station 120, and/or hybrid checkout station 130a, 130b by scanning a receipt or choosing an order and paying with a credit/debit card, cash, or other payment method. Food service data, for example, information related to items received, consumed, and wasted may be generated during checkout when a receipt is generated or during payment when the receipt is scanned. Food service data may be used to track inventory and/or for order fulfillment.

A recharge station 140 may include a touch screen terminal, a processor (e.g., a CPU), a bar code scanner, a radio frequency identification (RFID) tag reader, a magnetic strip reader (MSR), card dispenser, a cash receiving/dispensing device (e.g., a bill acceptor/recycler and/or coin mechanism), and printer, or some combination of the above. The recharge station 140 may be hardened for security. The recharge station 140 may be used to recharge a stored value card (SVC), obtain cash, etc. Purchase transactions may be completed at the recharge station 140, for example by scanning a receipt generated at one of the checkout stations.

Customers may use an ordering station 150 to place an order which may be customizable, for example, by choosing a side dish or specifying a type of pasta and protein for a pasta dish. The ordering station 150 may send orders to a kitchen printer, and may permit customers to and receive a receipt to verify payment at a pickup station. Purchase transactions may be also completed at the ordering station 150, for example by scanning the receipt.

As a component of the integrated service, table service may also be provided. A waiter/waitress may take orders from customers at a table or from customers in a queue to minimize wait times. The waiter/waitress may send orders to a kitchen printer and customer may pay the waiter/waitress or use a payment station. A paid receipt provided to the customer or a paid indication on a kitchen chit may be used to verify payment at pickup. Full administrative capabilities may also be provided in conjunction with table service.

A mobile application 160 may provide another method of ordering and payment. The mobile application 160 may operate on a user's mobile device 170 to permit users to browse menus and special offerings, create an order, and use an online payment account to effect payment. The mobile application 160 may also enable the mobile device 170 to effect payment transactions at a recharge station 140, full service checkout station 110a, 110b, self-service checkout station 120, and/or hybrid checkout station 130a, 130b.

Various embodiments for implementing an integrated food service system may include, but are not limited to, adding money to a stored value card (SVC) at a recharge station 140, selecting items for purchase, scanning the items for purchase at a self-service checkout station 120, and paying for the items with the SVC.

In various embodiments, items for purchase may be selected. The selected items may be scanned at a self-service checkout station 120, and a receipt may be generated. The receipt may be taken to a recharge station 140 where the receipt is scanned for a payment amount, and the amount due may be paid with a credit/debit card, cash, or other payment method.

In various embodiments, an order may be placed by a mobile device 170, for example, but not limited to, a smart phone or tablet, and an automatic payment made from an account registered with the vendor. The order may then be printed in the kitchen and prepared. Upon order pickup, a display on the customer's mobile device 170 may be scanned to confirm payment.

Customer facing digital signage/video screens 180 for communication with customers may also be provided. The digital signage/screens may be administered from common backend systems.

One of ordinary skill in the art will appreciate that various embodiments may include various configurations of on-site components without departing from the scope of the present inventive concept. For example, one or more self-service checkout stations 120 and/or one or more hybrid checkout stations 130a, 130b may be used in combination with one or more full service checkout stations 110a, 110b.

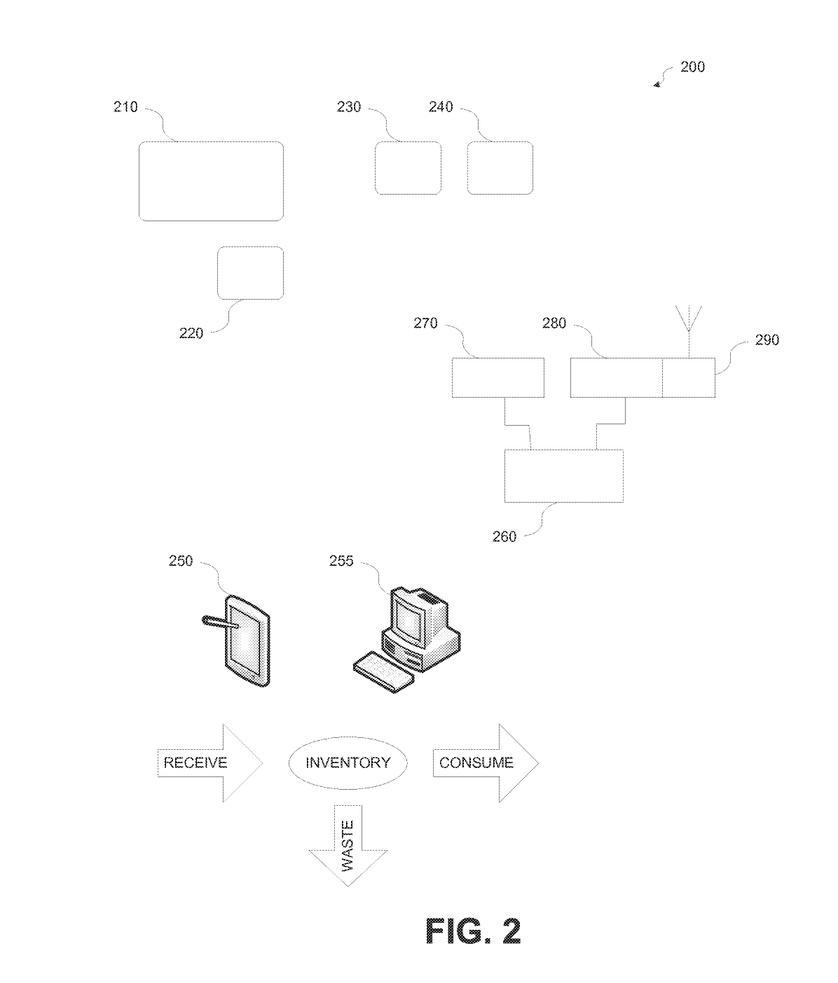

Additionally, an integrated food service system may include components that may be placed in the kitchen to provide kitchen service. FIG. 2 is a diagram illustrating a conceptual kitchen layout 200 according to various embodiments.

Referring to FIG. 2, kitchen components may include, but are not limited to, a touch screen expediter screen 210 configured to display and update customer orders, an expediter printer 220 configured to print orders for preparation, an order printer 230 configured to print an itemized order receipt and/or a print scan labels identifying a customer order to scan at checkout. The integrated food service system may also include mobile devices 250, for example, but not limited to, tablet computers, RFID scanners, etc., and stationary devices 255, for example, but not limited to, computers, etc., for tracking inventory receiving, consumption, and wasted products.

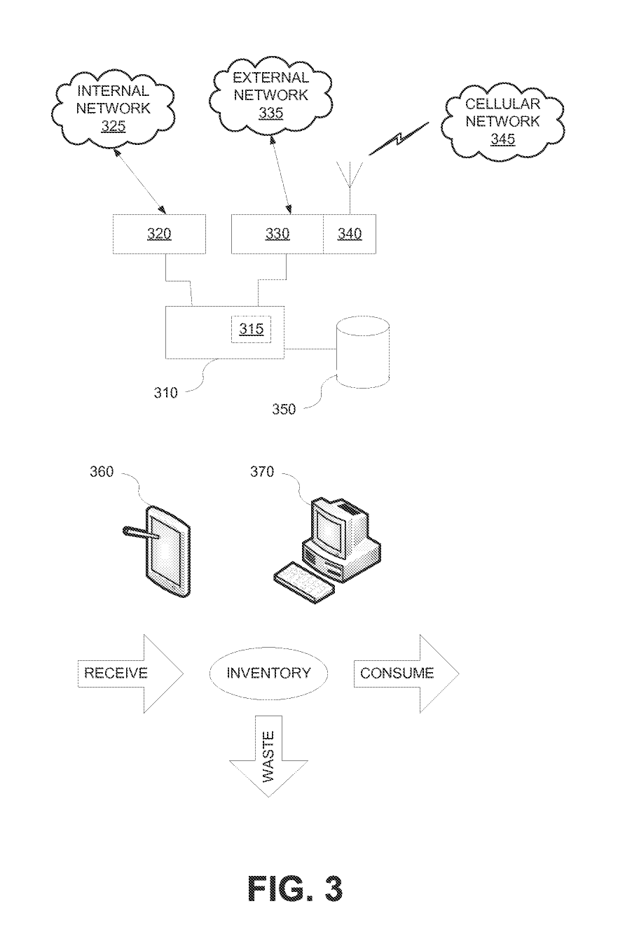

FIG. 3 is a diagram illustrating a communication and control system 300 according to various embodiments. Referring to FIG. 3, the communication and control system may include, for example, but not limited to, a hub server 310, an internal network router 320, an external network router 330, an external wireless router 340, and a data repository 350.

The hub server 310 may be configured to connect the various on-site components to an internal network 325 via the internal network router 320, and/or to an external network 335 via an external network router 330. The internal network router 320 may include a wired and/or wireless router and may be configured to provide communication among on-site components over an internal wired and/or wireless network 325. The external network router 330 may include a wired and/or wireless router and may be configured to provide communication between on-site components on the internal network 325 and an external network 335, for example, but not limited to, via the internet. The external wireless router 340 may be configured to provide communication between on-site components on the internal network 325 and an external cellular network 345 using various radio access technologies, for example, but not limited to, 3G and/or 4G radio access technologies. The internal network router 320, the external network router 330, and the external wireless router 340 may be devices known to those of skill in the art.

The hub server 310 may be configured to provide an administrative portal 315. The administrative portal 315 may be configured to provide communication between the data repository 350 and the one or more on-site components, for example, but not limited to, the full service checkout station 110a, 110b, the recharge station 140, etc. One of ordinary skill in the art will appreciate that the administrative portal 315 may be accessed by any authorized mobile and/or on-site component without departing from the scope of the various embodiments. The data repository 350 may include one or more storage devices, for example, but not limited to, hard disk drives (HDD), solid state drives, etc., or any combination thereof The hub server 310 may be configured to provide remote access to the food service data stored in the data repository 350 by an internet-connected device, for example a computer, a tablet, a mobile device, etc., via the administrative portal 315.

In various embodiments, inventory may be tracked and controlled. Mobile devices 360, for example, but not limited to, tablet computers, mobile phones, RFID readers, etc., as well as stationary devices 370, for example, but not limited to, desktop computers, may be configured to track inventory received, consumed, and wasted. The inventory data may be communicated to and from the mobile devices 360 and/or stationary devices 370 and/or other on-site components to and from the data repository 350 over the internal network 325 via the internal network router 320. Inventory data may also be updated via the administrative portal 315 over the internet and/or through the internal network router 320. Inventory data in the data repository 350 may be accessed by authorized devices via the internal network router 320 and also remotely over the internet via the administrative portal 315.

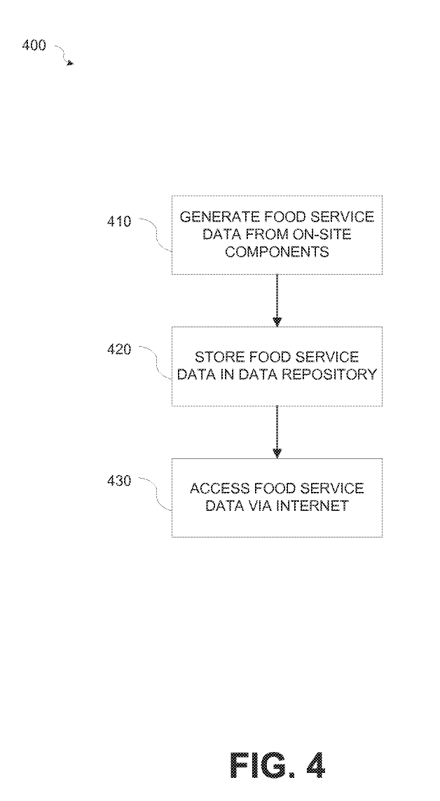

FIG. 4 is a flowchart for a method 400 according to various embodiments. Referring to FIG. 4, one or more mobile and/or on-site components of the integrated food service system may generate food service data (410). The generated food service data may include data related to inventory received during a delivery, inventory consumed, for example, items ordered at the ordering station 150, and or inventory wasted, for example spoiled or returned items.

The food service data may be stored in the data repository 350 (420). The one or more mobile and/or on-site components of the integrated food service system may communicate the food service data to the data repository 350, for example, over the internal network 325. The food service data may be stored in a database in the data repository 350. The food service data may be stored in the data repository 350 may be accessed over the internet through the administrative portal 315 (430).

One of ordinary skill in the art will appreciate that additional and/or alternate networking components enabling communication among the various components of the integrated food service system may be used without departing from the scope of the present inventive concept.

The accompanying claims and their equivalents are intended to cover such forms or modifications as would fall within the scope and spirit of the protection. For example, the example apparatuses, methods, and systems disclosed herein can be applied to self-service or assisted customer check-out and inventory monitoring systems. The various components illustrated in the figures may be implemented as, for example, but not limited to, software and/or firmware on a processor, ASIC/FPGA/DSP, or dedicated hardware. Also, the features and attributes of the specific example embodiments disclosed above may be combined in different ways to form additional embodiments, all of which fall within the scope of the present disclosure.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an,” or “the” is not to be construed as limiting the element to the singular.

The various illustrative logical blocks, units, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof If implemented in software, the functions may be stored as one or more instructions or code on a non-transitory computer-readable storage medium or non-transitory processor-readable storage medium. The steps of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. A method for integrated food service, the method comprising:
generating food service data from one or more on-site components;
storing the food service data in a data repository; and
accessing the food service data over the internet via an administrative portal,
wherein the administrative portal is configured to provide communication between the data repository and the one or more on-site components.

2. The method of claim 1, wherein the food service data is generated from an on-site component comprising at least one of a full service checkout station, a self-service checkout station, a hybrid checkout station, and a recharge station.

3. The method of claim 1, wherein the food service data is generated from a mobile device.

4. The method of claim 3, wherein the mobile device is a mobile phone.

5. The method of claim 3, wherein the mobile device is an RFID reader.

6. The method of claim 1, wherein the food service data is stored in a database in the data repository.

7. The method of claim 1, further comprising:
generating a receipt corresponding to items ordered from an ordering station; and
rendering payment at one of a full service checkout station, a self-service checkout station, a hybrid checkout station, and a recharge station based on the generated receipt.

8. The method of claim 7, wherein the food service data is generated based on the items ordered; and
the food service data is communicated to the data repository when the receipt is generated.

9. The method of claim 7, wherein the food service data is generated based on the items ordered; and
the food service data is communicated to the data repository when the receipt is scanned for payment.

10. The method of claim 1, wherein items are ordered using a mobile device, and an automatic payment is made from an account registered with a vendor.

11. The method of claim 10, wherein a display on the mobile device is scanned to confirm payment,
the food service data is generated based on the items ordered, and
the food service data is communicated to the data repository when the display on the mobile device is scanned.

12. The method of claim 1, wherein the food service data is accessed remotely from the data repository over the internet through the administrative portal with a mobile device.

13. A system for integrated food service, the system comprising:
one or more on-site components configured to generate food service data;
a data repository configured to store the generated food service data; and
an administrative portal,
wherein the administrative portal is configured to provide communication between the data repository and the one or more on-site components.

14. The system of claim 13, wherein the one or more on-site components comprise at least one of a full service checkout station, a self-service checkout station, a hybrid checkout station, a payment station, and an ordering station.

15. The system of claim 13, further comprising a mobile device configured to generate the food service data.

16. The system of claim 15, wherein the mobile device is a mobile phone.

17. The system of claim 15, wherein the mobile device is an RFID reader.

18. The system of claim 13, further comprising:
a hub server configured to provide the administrative portal;
an internal network router configured; and
an external network router,
wherein the hub server is configured to connect the on-site components to an internal network via the internal network router, and to an external network via the external network router.

19. The system of claim 18, wherein the hub server is configured to provide remote access to the food service data stored in the data repository by an internet-connected device via the administrative portal.

20. The system of claim 13, further comprising kitchen service components comprising:
a touch screen expediter screen configured to display and update orders;
an expediter printer configured to print orders for preparation;
an order printer configured to print an itemized order receipt; and
a label printer configured to print a scan label identifying an order.

21. The system of claim 20, wherein the scan label is scanned by a scanner at checkout, and
food service data is generated based on items ordered, and
the food service data is communicated to the data repository when the label is scanned.
